(19) United States
(12) Patent Application Publication
(10) Pub. No.: US 2003/0039340 A1
(43) Pub. Date: Feb. 27, 2003

(54) Adaptive instant messaging

(75) Inventors: Nikhil M. Deshpande, Beaverton, OR (US); Jay G. Gilbert, Portland, OR (US); Todd D. Harrison, Beaverton, OR (US)

Correspondence Address: Schwegman, Lundberg,, Woessner & Kluth, P.A., P.O. Box 2938, Minneapolis, MN, 55402, US

(73) Assignee: Intel Corporation

(21) Appl. No.: 09/938,778

(22) Filed: Aug. 24, 2001

(51) Int. Cl. H04M 11/00

(52) U.S. Cl. 379/88.16

(57) ABSTRACT

A method, apparatus, and system for communicating an instant message where the destination of the instant message may select whether to receive the instant message as text or speech independent of the origin of the instant message.

### FIELD

This invention relates generally to communication between computing devices and more particularly to instant messaging between computing devices in a network.

### COPYRIGHT NOTICE/PERMISSION

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright© Intel, Incorporated, 2001. All Rights Reserved.

### BACKGROUND

When computer networks, such as the Internet, first began, users sent electronic mail (email) to each other. Email is passed between nodes in a network using a “store-and-forward” technique where an email is stored at a node in a network until a short-lived connection is established to the next node, at which time the email is passed along. Eventually, after traveling through possibly multiple nodes, the email arrives at the destination node.

But, users wanted a faster way to communicate more akin to talking, so now instant messaging services are available that deliver messages faster than email and allow text-based communication to occur in a rapid, conversational fashion. Whereas email is a store-and-forward system based on short-lived connections, recipients listening for instant messages remain connected to their server on a long-lived connection. This long-lived connection allows instant messages to be delivered in close to real time.

Another difference of some instant messaging systems from email systems is that instant messages are delivered to a recipient if the recipient is listening for messages and there are no obstacles to delivery. Otherwise, the message is dropped, and the sender is informed of the delivery failure. Thus, in some instant messaging systems, messages are not queued or saved.

A still further difference of instant messaging from email is that email is fundamentally built on one-way message passing, while instant messaging systems are typically built on request-reply pairs. Many instant messaging services also include a presence function, which enables the instant messaging system (and also other users) to know when a particular user is online.

Yet another difference of instant messaging from email is that many instant messaging services have the concept of presence information. That is, the instant messaging service and a user know when other users are connected. An example of an instant messaging service that does not have presence information is SMS (Short Message Service), which provides the capability to send short messages to mobile digital phones.

Users may send and receive instant messages from and to a wide variety of client computing devices. For example, laptop or notebook computers, desktop computers, mainframe computers, handheld computers, and PDAs (Personal Digital Assistants) are a few of the possible client computing devices.

Also, users may operate the client devices in a wide variety of locations and circumstances. For example, one user might be in a meeting in a physical conference room and wish to have a side conversation via instant messaging without disturbing the other meeting participants. Another user might be alone in an automobile and wish to have hands-free operation of instant messaging, with no concern for the instant messages bothering others.

### BRIEF DESCRIPTION OF THE DRAWINGS

FIG. 1 depicts a block diagram of an embodiment of the invention.

FIG. 2 depicts a flowchart of processing for a transmit instant-message function at an origin-client device, according to an embodiment of the invention.

FIG. 3 depicts a flowchart of processing for a receive instant-message function at a destination-client device, according to an embodiment of the invention.

### DETAILED DESCRIPTION

In the following detailed description of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known circuits, structures and techniques have not been shown in detail in order not to obscure the invention.

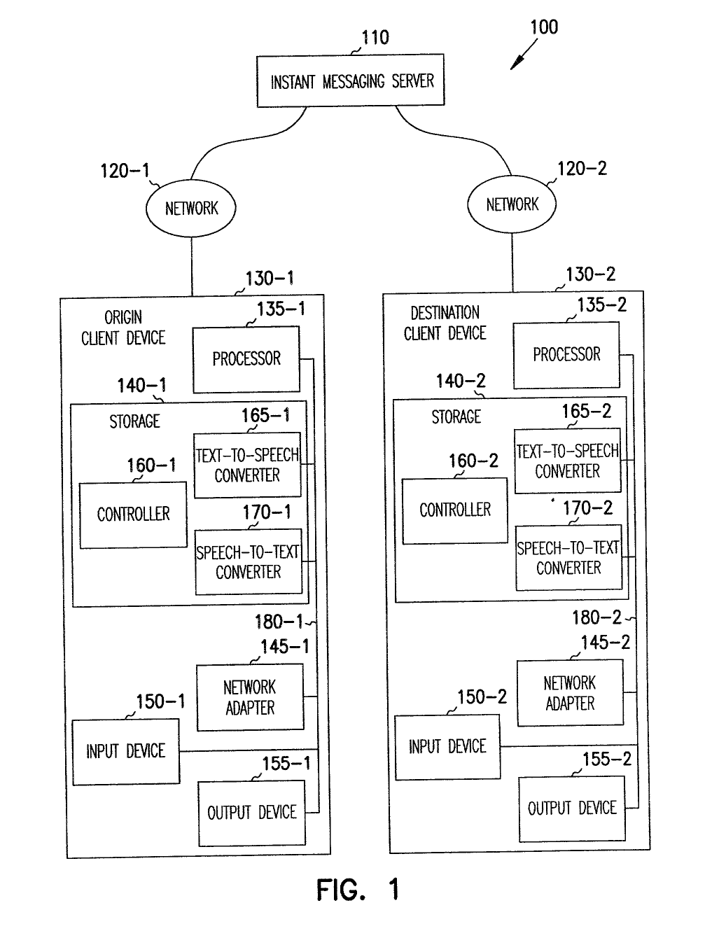

FIG. 1 depicts a block diagram of instant messaging system 100, according to an embodiment of the invention. Instant messaging system 100 includes instant-messaging server 110, networks 120-1 and 120-2, origin-client device 130-1, and destination-client device 130-2. Although two client devices (130-1 and 130-2) are shown, in other embodiments any number of client devices may be present.

Instant-messaging server 110 receives text messages across network 120-1 from origin-client devices, such as origin-client device 130-1, and forwards the text messages across network 120-2 to the appropriate destination-client device, such as destination-client device 130-2. Instant-messaging server 110 may be a server computer. Instant-messaging server 110 may use any suitable instant messaging functions. Examples of instant-messaging servers are those provided by AOL (America Online), Yahoo!, and Microsoft MSN Messenger Service, but any suitable instant-messaging server may be used. In another embodiment, instant-messaging server 110 may be provided by a paging service. Instant-messaging server 110 may be implemented using any suitable hardware and/or software, such as a personal computer available from a number of vendors. But, other examples may be portable computers, laptop computers, mainframe computers, or any other suitable type of hardware and/or software. The invention is not so limited. Instant-messaging server 110 may support any suitable instant messaging protocol. In an embodiment, instant-messaging server 110 supports the Internet Engineering Task Force's (IETF) Instant Messaging and Presence Protocol.

Networks 120-1 and 120-2 can be any suitable network capable of supporting instant messaging. Although two networks (120-1 and 120-2) are shown, in other embodiments any number of networks may be present and client devices may use the same network or different networks. In an embodiment, networks 120-1 and 120-2 may support wireless communications. In another embodiment, networks 120-1 and 120-2 may support hard-wired communications, such as a telephone line or cable. Networks 120-1 and 120-2 may support any appropriate protocol suitable for instant message. In an embodiment networks 120-1 and 120-2 are the Internet and support IP (Internet Protocol). In other embodiments, networks 120-1 and 120-2 may be a local area network (LAN) or a wide area network (WAN).

Origin-client device 130-1 includes processor 135-1, storage device 140-1, network adapter 145-1, input device 150-1, and output device 155-1, all communicatively coupled via bus 180-1. Origin-client device 130-1 may be an electronic computing device. Although origin-client device 130-1 is shown and described as being the origin of instant messages, in another embodiment it may also be the destination of instant messages.

Processor 135-1 represents a central processing unit of any type of architecture, such as a CISC (Complex Instruction Set Computing), RISC (Reduced Instruction Set Computing), VLIW (Very Long Instruction Word), or a hybrid architecture, although any appropriate processor may be used. Processor 135-1 executes instructions and includes that portion of client device 130-1 that controls the operation of the entire client device. Although not depicted in FIG. 1, processor 135-1 typically includes a control unit that organizes data and program storage in computer memory and transfers data and other information between the various parts of the client device. Processor 135-1 may receive input data from input device 150-1 and network adapter 145-1, read and store code and data in storage device 140-1, and may present output data to a user via output device 155-1. Processor 135-1 also may transmit and receive packets of information across network 120-1 using network adapter 145-1.

Although origin-client device 130-1 is shown to contain only a single processor and a single bus, the present invention applies equally to client devices that may have multiple processors and to client devices that may have multiple buses with some or all performing different functions in different ways.

Storage device 140-1 represents one or more mechanisms for storing data. For example, storage device 140-1 may include read only memory (ROM), random access memory (RAM), magnetic disk storage mediums, optical storage mediums, flash memory devices, and/or other machine-readable mediums. Although only one storage device 140-1 is shown, multiple storage devices and multiple types of storage devices may be present. Further, although origin-client device 130-1 is drawn to contain storage device 140-1, the storage device may be distributed across other electronic devices.

Storage device 140-1 contains controller 160-1, text-to-speech converter 165-1, and speech-to-text converter 170-1, which may include instructions capable of being executed on processor 135-1 to carry out the functions of the present invention. In another embodiment, some or all of the functions of the present invention may be carried out via hardware in lieu of a processor-based system. Of course, storage device 140-1 may also contain additional software and data (not shown), which is not necessary to understanding the invention.

Examples of text-to-speech converters and speech-to-text converters that may be used in embodiments of the invention include IBM ViaVoice, Dragon Systems Naturally Speaking, and Lucent Technologies Compact PCI (Peripheral Component Interconnect) Speech Processing Board. But, any suitable speech-to-text and text-to-speech converters may be used, and the invention is not so limited.

Bus 180-1 represents one or more busses (e.g., PCI, ISA (Industry Standard Architecture), X-Bus, EISA (Extended Industry Standard Architecture), or any other appropriate bus) and bridges (also termed bus controllers).

Input device 150-1 is that part of origin-client device 130-1 that accepts input from a user. In an embodiment, input device 150-1 may be a keyboard, but in other embodiments, input device 150-1 may be a pointing device, mouse, trackball, keypad, touchpad, touch screen, pointing stick, microphone, or any other appropriate input device. Although only one input device 150-1 is shown, in other embodiments any number of input devices of the same or of a variety of types may be present.

Output device 155-1 communicates information to the user of origin-client device 130-1. Output device 155-1 may be a cathode-ray tube (CRT) based video display well known in the art of computer hardware. But, in other embodiments output device 155-1 may be replaced with a liquid crystal display (LCD) based or gas, plasma-based, flat-panel display. In still other embodiments, any appropriate display device is used. In yet embodiments, a speaker that produces audio output may be used. Although only one output device 155-1 is shown, in other embodiments, any number of output devices of different types or of the same type may be present. In other embodiments, output device 155-1 might not be present.

Network adapter 145-1 facilitates communication between origin-client device 130-1 and network 120-1. Network adapter 145-1 provides a user of origin-client device 130-1 with a means of electronically communicating information, such as instant messages, with a remote computer, such as instant-messaging server 110. In addition, in another embodiment, network adapter 145-1 may support distributed processing, which enables origin-client device 130-1 to share a task with other devices linked to network 120-1. Although network adapter 145-1 is shown as part of origin-client device 130-1, in another embodiment they may be packaged separately. Although only one network adapter 145-1 is shown, in other embodiments, multiple network adapters of the same or of a variety of types may be present.

Origin-client device 130-1 may be implemented using any suitable hardware and/or software, such as a personal computer or other electronic computing device. Portable computers, laptop or notebook computers, mainframe computers, handheld devices, PDAs (Personal Digital Assistants), telephones, cellular telephones, smart phones, two-way alphanumeric pagers, and network computers or Internet appliances are examples of other possible configurations of electronic computing devices. The hardware and software depicted in FIG. 1 may vary for specific applications and may include more or fewer elements than those depicted. For example, other peripheral devices such as audio adapters, or chip programming devices, such as EPROM (Erasable Programmable Read-Only Memory) programming devices may be used in addition to or in place of the hardware already depicted. Thus, an embodiment of the invention may apply to any hardware configuration that supports instant messaging.

Destination-client device 130-2 includes processor 135-2, storage device 140-2, network adapter 145-2, input device 150-2, and output device 155-2, all communicatively coupled via bus 180-2. Destination-client device 130-1 may be an electronic computing device. Although destination-client device 130-2 is shown and described as being the destination of instant messages, in another embodiment it may also be the origin of instant messages.

Processor 135-2 represents a central processing unit of any type of architecture, such as a CISC (Complex Instruction Set Computing), RISC (Reduced Instruction Set Computing), VLIW (Very Long Instruction Word), or a hybrid architecture, although any appropriate processor may be used. Processor 135-2 executes instructions and includes that portion of client device 130-2 that controls the operation of the entire client device. Although not depicted in FIG. 1, processor 135-2 typically includes a control unit that organizes data and program storage in computer memory and transfers data and other information between the various parts of the client device. Processor 135-2 may receive input data from input device 150-2 and network adapter 145-2, read and store code and data in storage device 140-2, and may present output data to a user via output device 155-2. Processor 135-2 also may transmit and receive packets of information across network 120-2 using network adapter 145-2.

Although destination-client device 130-2 is shown to contain only a single processor and a single bus, the present invention applies equally to client devices that may have multiple processors and to client devices that may have multiple buses with some or all performing different functions in different ways.

Storage device 140-2 represents one or more mechanisms for storing data. For example, storage device 140-2 may include read only memory (ROM), random access memory (RAM), magnetic disk storage mediums, optical storage mediums, flash memory devices, and/or other machine-readable mediums. Although only one storage device 140-2 is shown, multiple storage devices and multiple types of storage devices may be present. Further, although destination-client device 130-2 is drawn to contain storage device 140-2, in other embodiments storage device 140-2 may be distributed across other electronic devices.

Storage device 140-2 contains controller 160-2, text-to-speech converter 165-2, and speech-to-text converter 170-2, which may include instructions capable of being executed on processor 135-2 to carry out the functions of the present invention. In another embodiment, some or all of the functions of the present invention may be carried out via hardware in lieu of a processor-based system. Of course, storage device 140-2 may also contain additional software and data (not shown), which is not necessary to understanding the invention.

Examples of text-to-speech converters and speech-to-text converters that may be used in embodiments of the invention include IBM ViaVoice, Dragon Systems Naturally Speaking, and Lucent Technologies Compact PCI (Peripheral Component Interconnect) Speech Processing Board. But, any suitable speech-to-text and text-to-speech converters may be used, and the invention is not so limited.

Bus 180-2 represents one or more busses (e.g., PCI, ISA (Industry Standard Architecture), X-Bus, EISA (Extended Industry Standard Architecture), or any other appropriate bus) and bridges (also termed bus controllers).

Input device 150-2 is that part of destination-client device 130-2 that accepts input from a user. In an embodiment, input device 150-2 may be a keyboard, but in other embodiments, input device 150-2 may be a pointing device, mouse, trackball, keypad, touchpad, touch screen, pointing stick, microphone, or any other appropriate input device. Although only one input device 150-2 is shown, in other embodiments any number of input devices of the same or of a variety of types may be present.

Output device 155-2 communicates information to the user of destination-client device 130-2. Output device 155-2 may be a cathode-ray tube (CRT) based video display well known in the art of computer hardware. But, in other embodiments output device 155-2 may be replaced with a liquid crystal display (LCD) based or gas, plasma-based, flat-panel display. In still other embodiments, any appropriate display device is used. In yet embodiments, a speaker that produces audio output may be used. Although only one output device 155-2 is shown, in other embodiments, any number of output devices of different types or of the same type may be present.

Network adapter 145-2 facilitates communication between destination-client device 130-2 and network 120-2. Network adapter 145-2 provides a user of destination-client device 130-2 with a means of electronically communicating information, such as instant messages, with a remote computer, such as instant-messaging server 110. In addition, in another embodiment, network adapter 145-2 may support distributed processing, which enables destination-client device 130-2 to share a task with other devices linked to network 120-2. Although network adapter 145-2 is shown as part of destination-client device 130-2, in another embodiment they may be packaged separately. Although only one network adapter 145-2 is shown, in other embodiments, multiple network adapters of the same or of a variety of types may be present.

Destination-client device 130-2 may be implemented using any suitable hardware and/or software, such as a personal computer or other electronic computing device. Portable computers, laptop or notebook computers, mainframe computers, handheld devices, PDAs (Personal Digital Assistants), telephones, cellular telephones, smart phones, two-way alphanumeric pagers, and network computers or Internet appliances are examples of other possible configurations of electronic computing devices. The hardware and software depicted in FIG. 1 may vary for specific applications and may include more or fewer elements than those depicted. For example, other peripheral devices such as audio adapters, or chip programming devices, such as EPROM (Erasable Programmable Read-Only Memory) programming devices may be used in addition to or in place of the hardware already depicted. Thus, an embodiment of the invention may apply to any hardware configuration that supports instant messaging.

As will be described in detail below, aspects of an embodiment pertain to specific apparatus and method elements implementable on client devices. In another embodiment, the invention may be implemented as a program product for use with a client device. The programs defining the functions of this embodiment may be delivered to a client device via a variety of signal-bearing media, which include, but are not limited to:

(1) information permanently stored on a non-rewriteable storage medium (e.g., read only memory devices within a client device such as CD-ROM readable by a CD-ROM drive;

(2) alterable information stored on a rewriteable storage medium (e.g., a hard disk drive or diskette); or

(3) information conveyed to a client device by a communications medium, such as through a computer or telephone network accessed via network adapter 145-1 or 145-2, including wireless communications.

Such signal-bearing media, when carrying processor-readable instructions that direct the functions of the present invention, represent embodiments of the present invention.

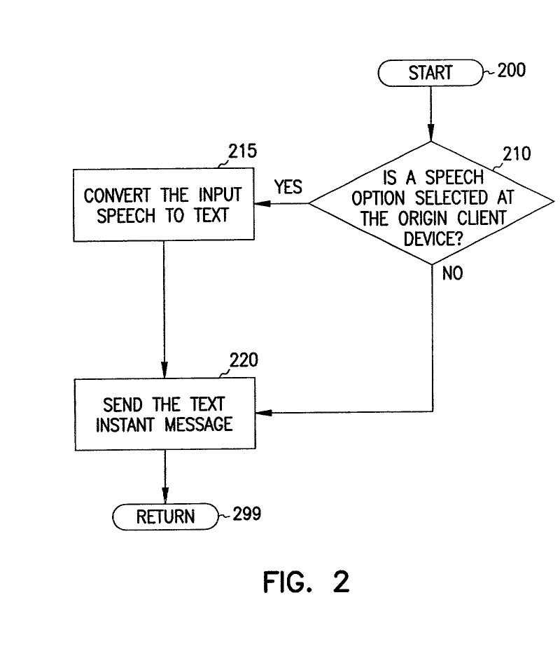

FIG. 2 depicts a flowchart of processing for a transmit instant-message function at origin-client device 130-1, according to an embodiment of the invention. Control begins at block 200. Control then continues to block 210 where controller 160-1 determines whether the speech option in origin-client device 130-1 is selected. When the speech option is selected, the user is to input speech via input device 150-1. If the determination at block 210 is true, then control continues to block 215 where origin-client device 130-1 converts the speech input to text using speech-to-text converter 170-1. Control then continues to block 220 where the origin-client device 130-1 transmits the text to instant-messaging server 110 over network 120-1 using network adapter 145-1. Control then continues to block 299 where the function returns.

If the determination at block 210 is false, then control continues directly to block 220 where controller 160-1 transmits the input-text message to instant-messaging server 110 over network 120-1 using network adapter 145-1. Control then continues to block 299 where the function returns.

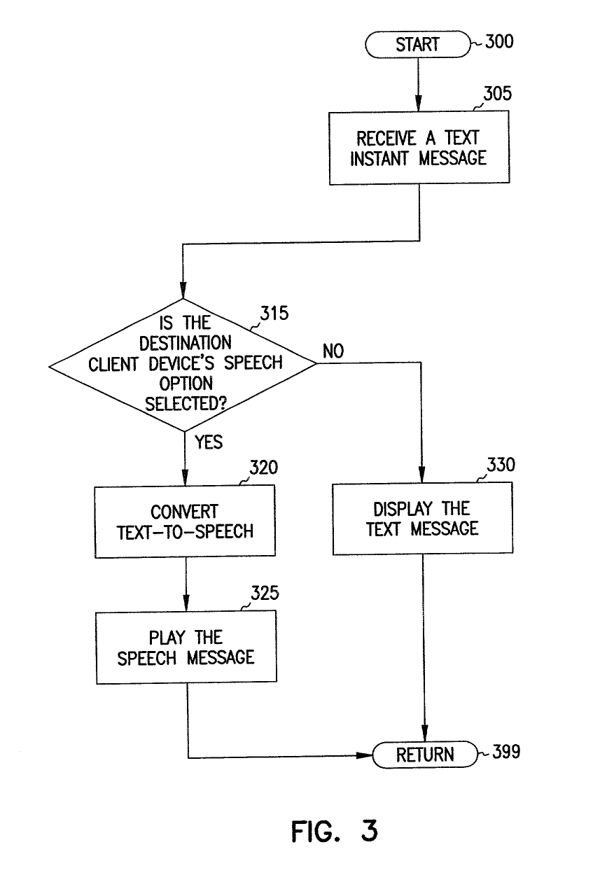

FIG. 3 depicts a flowchart of the processing for a receive instant-message function at destination-client device 130-2, according to an embodiment of the invention. Control begins at block 300. Control then continues to block 305 where destination-client device 130-2 receives a text instant message from instant-messaging server 110 across network 120-2 via network adapter 145-2.

Control then continues to block 315 where controller 160-2 determines whether the speech option in destination-client device 130-2 is selected. The speech option in destination-client device 130-2 is independent of the speech option in origin-client device 130-1, so that the origin user and the destination user may use different, or the same, speech options. If the determination at block 315 is true, then control continues to block 320 where destination-client device 130-2 converts the received text message to speech using text-to-speech converter 165-2. Control then continues to block 325 where controller 160-2 sends speech to output device 155-2, which plays the speech for the user. Control then continues to block 399 where the function returns.

If the determination at block 315 is false, then control continues to block 330 where controller 160-2 sends the text message to output device 155-2, which displays the text message. Control then continues to block 399 where the function returns.

What is claimed is:

1. A method, comprising:
determining whether a speech option is selected at an origin device; and
when the speech option is selected, converting input speech to text and transmitting an instant message comprising the text.

2. The method of claim 1, farther comprising:
when speech is not selected at the origin device, receiving input text and transmitting the instant message, wherein the instant message comprises the input text.

3. The method of claim 2, further comprising:
receiving the instant message;
determining whether a speech option is selected at a destination device; and
when the speech option is selected at the destination device, converting the input text to speech.

4. The method of claim 1, further comprising:
receiving the instant message;
determining whether a speech option is selected at a destination device; and
when the speech option is selected at the destination device, converting the text to speech.

5. The method of claim 4, wherein the speech option at the destination device is independent of the speech option at the origin device.

6. A method, comprising:
receiving an instant message at a destination-client device, wherein the instant message comprises text; and
determining whether a speech option at the destination-client device is selected and if true converting the text to speech.

7. The method of claim 6, wherein when the determining operation is false, displaying the text.

8. The method of claim 6, wherein the speech option at the destination-client device is independent of a speech option at an origin-client device, wherein the origin-client device originated the instant message.

9. The method of claim 6, wherein the instant message is received across a long-lived connection.

10. A computing device, comprising:
a text-to-speech converter to convert text in a received instant message to speech when a speech option is selected, independent of whether a sender of the instant message performed speech input.

11. The computing device of claim 10, further comprising:
a speech-to-text converter to convert speech to text in an instant message to be transmitted when the speech option is selected.

12. The computing device of claim 9, wherein the received instant message is received across a long-lived connection.

13. The computing device of claim 9, wherein the received instant message is received via a request-reply pair.

14. An instant-messaging system, comprising:
an instant-messaging server;
a controller to determine whether a speech option is selected at an origin-client device and to send an instant message to the instant-messaging server; and
a speech-to-text converter to convert speech to text when the speech option is selected, wherein the instant message comprises the text.

15. The instant-messaging system of claim 14, wherein the instant-messaging server is to receive the instant message on a long-lived connection.

16. The instant-messaging system of claim 14, wherein the instant-messaging server is to send the instant message to a destination-client device.

17. The instant-messaging system of claim 14, wherein the instant-messaging server is to drop the instant message when a destination-client device is not connected.

18. The instant-messaging system of claim 14, further comprising:
a destination controller to determine whether a speech option is selected at a destination-client device; and
a text-to-speech converter to convert text to speech when the speech option at the destination-client device is selected independent of the speech option at an the origin-client device.

19. An instant-messaging system, comprising:
an instant messaging server;
an origin-client device, comprising:
an origin controller to determine whether an origin-speech option is selected at the origin-client device and to send an instant message to the instant-messaging server,
a speech-to-text converter to convert speech to text when the origin-speech option is selected, wherein the instant message comprises the text; and
a destination-client device, comprising:
a destination controller to determine whether a destination-speech option is selected at the destination-client device and to receive the instant message from the instant-messaging server, and
a text-to-speech converter to convert the text to speech when the destination-speech option is selected.

20. The instant-messaging system of claim 19, wherein the origin-speech option is independent of the destination-speech option.

21. A signal-bearing medium comprising instructions, wherein the instructions when read and executed by a processor comprise:
determining whether a speech option is selected at an origin device; and
when the speech option is selected, converting input speech to text and transmitting an instant message to an instant-messaging server, wherein the instant message comprises the text.

22. The signal-bearing medium of claim 21, further comprising:
when speech is not selected at the origin device, receiving input text and transmitting the instant message to the instant-messaging server, wherein the instant message comprises the input text.

23. The signal-bearing medium of claim 21, further comprising:
receiving the instant message from the instant-messaging server;
determining whether a speech option is selected at a destination device; and
when the speech option is selected at the destination device, converting the text to speech.

24. The signal-bearing medium of claim 22, further comprising:
receiving the instant message from the instant-messaging server;
determining whether a speech option is selected at a destination device; and
when the speech option is selected at the destination device, converting the input text to speech.

25. The signal-bearing medium of claim 23, wherein the speech option at the destination device is independent of the speech option at the origin device.

26. A pager, comprising:
a text-to-speech converter to convert text in a received instant message to speech when a speech option is selected, independent of whether a sender of the instant message performed speech input.

27. The pager of claim 26, further comprising:
a speech-to-text converter to convert speech to text in an instant message to be transmitted when the speech option is selected.

28. The pager of claim 26, wherein the received instant message is received across a long-lived connection.

29. The pager device of claim 26, wherein the received instant message is received via a request-reply pair.
